(19) United States
(12) Patent Application Publication
(10) Pub. No.: US 2014/0319411 A1
(43) Pub. Date: Oct. 30, 2014

(54) SEMICONDUCTOR WAFER POLISHING LIQUID COMPOSITION

(71) Applicants: Hiroaki Sakaida, Sodegaura-shi (JP); Fumiaki Araki, Sodegaura-shi (JP); Yoshiyuki Kashima, Sodegaura-shi (JP)

(72) Inventors: Hiroaki Sakaida, Sodegaura-shi (JP); Fumiaki Araki, Sodegaura-shi (JP); Yoshiyuki Kashima, Sodegaura-shi (JP)

(73) Assignee: NISSAN CHEMICAL INDUSTRIES, LTD., Tokyo (JP)

(21) Appl. No.: 14/357,673

(22) PCT Filed: Nov. 16, 2011
(86) PCT No.: PCT/JP2011/076418

§ 371 Date: May 12, 2014

(51) Int. Cl. C09G 1/02

(52) U.S. Cl. CPC C09G 1/02
USPC 252/79.1

(57) ABSTRACT

There is provided a polishing liquid composition that can effectively reduce LPDs having a size of 50 nm or less on a wafer surface in polishing of semiconductor wafers. A semiconductor wafer polishing liquid composition including: water; silica particles; an alkaline compound; a water-soluble polymer compound; and polyethylene glycol, wherein the semiconductor wafer polishing liquid composition satisfies conditions (a) to (c): (a) a shape factor SF1 of the silica particles is 1.00 to 1.20, (b) a mean primary particle diameter of the silica particles that is obtained by a nitrogen adsorption method is 5 nm to 100 nm, and a coefficient of particle diameter variation CV value obtained from image analysis of the transmission electron microscope image is in a range of 0% to 15%, and (c) the polyethylene glycol has a number average molecular weight of 200 to 15,000.

### TECHNICAL FIELD

The invention in this application relates to a polishing liquid composition suitable for reducing LPDs in mirror-polishing of semiconductor wafer surfaces.

### BACKGROUND ART

A manufacturing method for semiconductor wafers generally includes 1) a slice process of slicing a single-crystal ingot to obtain a thin disk-shaped wafer, 2) a chamfering process of chamfering the outer periphery of the wafer, 3) a lapping process of planarizing the chamfered wafer, 4) an etching process of removing processing distortion of the lapped wafer, 5) a polishing process of mirror-finishing the surface of the etched wafer, and 6) a cleaning process of cleaning the polished wafer.

The polishing process is performed by relatively moving a semiconductor wafer to be polished in pressure contact with a polishing pad while a polishing liquid composition is supplied onto the surface of the polishing pad. The polishing process generally includes multiple stages of primary polishing, secondary polishing, and final polishing. The primary polishing and the secondary polishing aim to remove deep flaws on the wafer surface that are produced in the lapping and etching processes, whereas the final polishing aims to remove surface defects remaining after the primary polishing and the secondary polishing and to achieve planarization at high accuracy. Light point defects (LPDs) and a haze level (the degree of surface fogging) are generally used as criteria for evaluating the quality of semiconductor wafers after the final polishing.

An LPD is a minute surface defect that causes diffuse reflection when a semiconductor wafer in a mirror surface state is irradiated with intensive light, and results from scratches caused by coarse abrasive grains and foreign substances during polishing, adhesion of abrasive grains and foreign substances, or a degraded layer caused by adhesion of abrasive grains and foreign substances.

A haze level refers to the degree of fogging that appears in reflected light when a semiconductor wafer in a mirror surface state is irradiated with intensive light. As the flatness of a semiconductor wafer increases, diffuse reflection decreases and the haze level improves. It can be said that a wafer with a smaller number of LPDs and a smaller value of the haze level has higher quality.

In the final polishing process performed for the purpose of reducing LPDs and the haze level, a polishing liquid composition is generally used in which an alkaline compound is added and then a water-soluble polymer compound is added to silica particles dispersed in water. The water-soluble polymer compound has stress relaxing ability and thus is effective not only in reducing damage by abrasive grains and foreign substances but also in imparting affinity for water to the semiconductor wafer surface and preventing adhesion of abrasive grains and foreign substances. Addition of a compound having an alcoholic hydroxy group for improving wettability of the semiconductor wafer interface can further improve the effect of reducing scratches and preventing adhesion and achieve planarization at high accuracy.

With shrinkage of line-width designed on semiconductor wafers today, the requirements for LPDs and the haze level of semiconductor wafers have become even higher. Rapid progress in surface defect analyzers enables observation of LPDs, in particular, down to the order of 50 nm or less. The thus found defects on the order of a few tens of nm are not suppressed effectively with conventional polishing liquid compositions.

Patent Document 1 discloses a polishing liquid composition containing hydroxyethyl cellulose, more than 0.005% by mass and less than 0.5% by mass of polyethylene oxide, an alkaline compound, water, and silicon dioxide. However, there is no suggestion as to the effectiveness in reduction of LPDs of 50 nm or less.

Patent Document 2 discloses that modified silica-based fine particles that are spherical, have high surface smoothness, have a narrow particle diameter distribution, and substantially include no coarse particles are used as a component of a polishing composition to achieve performance well balanced in the polishing rate, the surface roughness of the polished substrate, and prevention of linear marks on the polished substrate. However, it is unknown how effective it is in reduction of LPDs.

### PRIOR ART DOCUMENTS

### Patent Documents

Patent Document 1: Japanese Patent Application Publication No. 2004-128089 (JP 2004-128089 A)

Patent Document 2: Japanese Patent Application Publication No. 2008-273780 (JP 2008-273780 A)

### SUMMARY OF THE INVENTION

### Problem to be Solved by the Invention

The invention in the present application aims to provide a polishing liquid composition that can effectively reduce LPDs having a size of 50 nm or less on a wafer surface in polishing of semiconductor wafers.

### Means for Solving the Problem

The invention in the present application provides: as a first aspect, a semiconductor wafer polishing liquid composition comprising: water; silica particles; an alkaline compound; a water-soluble polymer compound; and polyethylene glycol, in which the semiconductor wafer polishing liquid composition satisfies conditions (a) to (c):

(a) a shape factor SF1 of the silica particles as represented by Expression (1) below is 1.00 to 1.20,

SF1=(D_{L}²×π/4)/S (1)

(where D_{L} is the maximum length (nm) of a silica particle obtained from a transmission electron microscope image, and S is a projected area (nm²) of a silica particle),

(b) a mean primary particle diameter of the silica particles that is obtained by a nitrogen adsorption method is 5 nm to 100 nm, and a coefficient of particle diameter variation CV value obtained from image analysis of the transmission electron microscope image is in a range of 0% to 15%, and

(c) the polyethylene glycol has a number average molecular weight of 200 to 15,000;

as a second aspect, the semiconductor wafer polishing liquid composition according to the first aspect, in which the alkaline compound is an inorganic salt of an alkali metal and/or an ammonium salt;

as a third aspect, the semiconductor wafer polishing liquid composition according to the second aspect, in which the inorganic salt of an alkali metal is at least one selected from the group consisting of lithium hydroxide, sodium hydroxide, potassium hydroxide, lithium carbonate, sodium carbonate, potassium carbonate, lithium hydrogen carbonate, sodium hydrogen carbonate, and potassium hydrogen carbonate;

as a fourth aspect, the semiconductor wafer polishing liquid composition according to the second aspect, in which the ammonium salt is at least one selected from the group consisting of ammonium hydroxide, ammonium carbonate, ammonium hydrogen carbonate, tetramethylammonium hydroxide, tetraethylammonium hydroxide, tetramethylammonium chloride, and tetraethylammonium chloride;

as a fifth aspect, the semiconductor wafer polishing liquid composition according to the first aspect, in which the water-soluble polymer compound is at least one compound selected from the group consisting of a cellulose derivative and a polyvinyl alcohol; as a sixth aspect, the semiconductor wafer polishing liquid composition according to the fifth aspect, in which the cellulose derivative is at least one compound selected from the group consisting of carboxymethyl cellulose, hydroxyethyl cellulose, hydroxyethylmethyl cellulose, hydroxypropyl cellulose, hydroxypropylmethyl cellulose, methyl cellulose, ethyl cellulose, ethylhydroxyethyl cellulose, and carboxymethylethyl cellulose;

as a seventh aspect, the semiconductor wafer polishing liquid composition according to the fifth aspect, in which the cellulose derivative is hydroxyethyl cellulose having a weight average molecular weight of 100,000 to 3,000,000 in terms of polyethylene oxide;

as an eighth aspect, the semiconductor wafer polishing liquid composition according to any one of the first to seventh aspects, in which an amount of the silica particles contained is 0.005% to 50% by mass relative to a total mass of the semiconductor wafer polishing liquid composition;

as a ninth aspect, the semiconductor wafer polishing liquid composition according to any one of the first to eighth aspects, in which an amount of the alkaline compound contained is 0.001% to 30% by mass relative to the total mass of the semiconductor wafer polishing liquid composition;

as a tenth aspect, the semiconductor wafer polishing liquid composition according to any one of the first to ninth aspects, in which an amount of the water-soluble polymer compound contained is 0.01% to 2.0% by mass relative to the total mass of the semiconductor wafer polishing liquid composition; and

as an eleventh aspect, the semiconductor wafer polishing liquid composition according to any one of the first to tenth aspects, in which an amount of the polyethylene glycol contained is 0.01% to 0.5% by mass relative to the total mass of the semiconductor wafer polishing liquid composition.

### Effects of the Invention

According to the invention in the present application, silica particles having a spherical shape and having a particle size distribution controlled uniformly are used in combination with polyethylene glycol having a particular molecular weight, so that damage to a semiconductor wafer surface can be reduced, and adhesion of abrasive grains and foreign substances can be prevented. A semiconductor wafer in which LPDs of 50 nm or less are reduced is thus provided.

### MODES FOR CARRYING OUT THE INVENTION

A semiconductor wafer polishing liquid composition of the invention in the present application includes water, silica particles, an alkaline compound, a water-soluble polymer compound, and polyethylene glycol.

[Silica Particles]

The silica particles have a shape factor SF1 of 1.00 to 1.20 as represented by Expression (1) below.

SF1=(D_{L}²×π/4)/S (1)

(where D_{L} is the maximum length (nm) of a silica particle obtained from a transmission electron microscope image, and S is a projected area (nm²) of a silica particle).

In Expression (1), D_{L} is the maximum length (the maximum length between any two points on the circumference in the image) of a silica particle obtained from image analysis of a transmission electron microscope (TEM) image, and S is a projected area of a silica particle obtained from image analysis of the transmission electron microscope image. Specifically, the projected area is obtained by scanning the transmission electron microscope image taken at a magnification of 200,000 at a resolution of 150 dpi (dot/inch), capturing the scanned electronic data into an image analyzer, and converting the number of pixels occupied by a silica particle into an area. For example, in the image at a magnification of 200,000, one inch is equivalent to 127 nm. The length of one side of one dot is 0.847 nm, and the area per dot is converted into 0.717 nm².

The SF1 is obtained by obtaining the maximum length D_{L} and the projected area S of each of about 1000 particles recognized with the image analyzer, calculating the value of Expression (1) for each particle, and obtaining the mean value of the calculated values as an SF1.

The SF1 closer to 1.00 indicates that the shape is closer to a spherical form. With the value of SF1 in the range described above, defects and damage on a semiconductor wafer can be reduced. In the invention in the present application, in order for LPDs on the wafer surface to be further reduced, the SF1 is more preferably in a range of 1.00 to 1.18 and the most preferably in a range of 1.00 to 1.15.

The primary particle diameter of the silica particles that is obtained through a nitrogen adsorption method is 5 nm to 100 nm. The primary particle diameter of less than 5 nm decreases the polishing rate, is likely to cause aggregation of particles, and reduces the stability of the polishing liquid composition. The primary particle diameter of greater than 100 nm is likely to cause scratches on the semiconductor wafer surface and deteriorates the flatness of the polished surface.

In the invention in the present application, in order for LPDs on the semiconductor wafer surface to be further reduced with the effects of the particle shape and without reducing the polishing rate, the primary particle diameter of silica particles used is preferably in a range of 10 nm to 70 nm and more preferably in a range of 20 nm to 50 nm.

The coefficient of particle diameter variation CV value of the silica particles as represented by Expression (2) below is 0% to 15%.

CV value (%)=σ/D_{A}×100 (2)

(where σ is a particle diameter standard deviation and D_{A} is a mean particle diameter).

In Expression (2), σ and D_{A} are obtained from image analysis of a transmission electron microscope image. Specifically, for any 1000 particles in a transmission electron microscope image of silica particles, each particle diameter is obtained using an image analyzer (for example, NIRECO CORPORATION: LUZEX AP), and D_{A} (nm) and a are calculated from the obtained values. The distribution is more uniform as the CV value is closer to 0%.

In the invention in the present application, in order for LPDs on the semiconductor wafer surface to be reduced, the CV value is preferably 10% or less and more preferably 7% or less.

The silica particles are colloidal silica and preferably produced from an aqueous alkaline silicate solution or an alkyl silicate as a raw material.

A preferable process for producing the silica particles is as follows. In a case where an aqueous alkaline silicate solution is used as a raw material, an aqueous silicate solution obtained from an aqueous alkaline silicate solution through dealkalization or a stabilized aqueous silicate solution obtained by adding a small amount of an alkaline compound to an aqueous silicate solution is added to a heel liquid to allow the particle diameter of the silica particles to grow. In doing so, the heel liquid used is composed of water, an alkaline compound, and colloidal silica particles serving as nuclei of primary particle diameters of 3 nm to 25 nm, or of water and an alkaline compound.

In the particle growth reaction of the silica particles, the reaction temperature is preferably 90° C. to 150° C. The mole ratio of SiO₂/M₂O (M is an alkali metal) of the heel liquid is preferably 0 to 40. The addition rate of the aqueous silicate solution or the stabilized aqueous silicate solution is preferably set such that the mole ratio of SiO₂/M₂O (M is an alkali metal) of a reaction medium increases at 0.01 to 0.5 per minute.

In a case where alkyl silicate is used as a raw material in the process for producing silica particles, preferably, alkyl silicate is added to a heel liquid to allow the particle diameter of silica particles to grow. In doing so, the heel liquid is composed of water, an alkaline compound, and colloidal silica particles serving as nuclei of primary particle diameters of 3 nm to 25 nm, or of water and an alkaline compound.

In the particle growth reaction of the silica particles, the reaction temperature is preferably 45° C. or higher and equal to or lower than the boiling point of the reaction medium. The concentration of the alkaline compound in the heel liquid is preferably 0.002 to 0.1 moles per liter of the heel liquid, and the concentration of water is preferably 30 moles or more per liter of the heel liquid. The amount of alkyl silicate added is preferably 7 to 80 moles in terms of Si atoms with respect to 1 mole of the alkaline compound in the heel liquid. The addition rate of alkyl silicate is preferably set such that the mole ratio of SiO₂/M′OH (M′OH is an alkali metal hydroxide or an ammonium hydroxide) of the reaction medium increases at 0.1 to 1.0 per minute.

The silica particles for use can also be those obtained by adjusting the colloidal silica obtained by the process described above such that the SiO₂ concentration is 10% to 30% by mass, and performing a hydrothermal process at temperatures of 120° C. to 300° C. for about 2 to 20 hours.

In a case where coarse particles of 0.5 μm or more are included in the silica particles, the coarse particles have to be removed. Examples of the process of removing the coarse particles include forced sedimentation and microfiltration. Examples of the filter for use in microfiltration include depth filters, pleated filters, membrane filters, and hollow-fiber filters, any of which can be used. Examples of the materials of the filters include cotton, polypropylene, polystyrene, polysulfone, polyethersulfone, nylon, cellulose, and glass, any of which can be used. The filtration accuracy of filters is expressed by the absolute filtration accuracy (the size of particles captured 99.9% or more). The silica particles as described above are preferably processed with a filter with an absolute filtration accuracy of 0.5 μm to 1.0 μm in view of production efficiency (the process time, clogging of the filter, and other reasons).

The amount of the silica particles contained is generally 0.05% to 50% by mass, preferably 0.1% to 20% by mass, and further preferably 5% to 10% by mass with respect to the mass of the whole quantity of the polishing liquid composition (the total mass of the polishing liquid composition). With 0.05% by mass or less, the polishing performance is not achieved sufficiently. With 50% by mass or more, the stability of the polishing liquid composition is bad.

[Alkaline Compound]

The alkaline compound is an inorganic salt of an alkali metal and/or an ammonium salt, which act as process promoters. The inorganic salt of an alkali metal is at least one selected from the group consisting of lithium hydroxide, sodium hydroxide, potassium hydroxide, lithium carbonate, sodium carbonate, potassium carbonate, lithium hydrogen carbonate, sodium hydrogen carbonate, and potassium hydrogen carbonate. Sodium hydroxide, potassium hydroxide, sodium carbonate, and potassium carbonate are particularly preferable.

The ammonium salt is at least one selected from the group consisting of ammonium hydroxide, ammonium carbonate, ammonium hydrogen carbonate, tetramethylammonium hydroxide, tetraethylammonium hydroxide, tetramethylammonium chloride, and tetraethylammonium chloride. Among those, ammonium hydroxide is preferable.

The preferable amount of the alkali compound added is generally 0.01 to 30% by mass with respect to the mass of the whole quantity of the polishing liquid composition, though it varies depending on the substance used. In particular when an alkali metal salt is used as the alkali compound, the amount added is preferably 0.01% to 1.0% by mass. When an ammonium salt is used, the amount added is preferably 0.01% to 5% by mass. The addition of less than 0.01% by mass does not achieve a sufficient effect as a process promoter. Conversely, the addition of 30% by mass or more does not promise further improvement in polishing performance. The alkaline compounds listed above may be used in combination of two or more.

[Water-Soluble Polymer Compound]

The water-soluble polymer compound is at least one compound selected from the group consisting of a cellulose derivative and a polyvinyl alcohol. The weight average molecular weight of the water-soluble polymer compound is measured using gel permeation chromatography (GPC), and the weight average molecular weight (Mw) in terms of polyethylene oxide is 100,000 to 3,000,000, preferably 300,000 to 2,500,000, and more preferably 500,000 to 2,000,000.

The cellulose derivative is at least one compound selected from the group consisting of carboxymethyl cellulose, hydroxyethyl cellulose, hydroxyethylmethyl cellulose, hydroxypropyl cellulose, hydroxypropylmethyl cellulose, methyl cellulose, ethyl cellulose, ethylhydroxyethyl cellulose, and carboxymethylethyl cellulose. Among those, hydroxyethyl cellulose is more preferable.

The amount of the water-soluble polymer compound added is preferably 0.01% to 2.0% by mass with respect to the mass of the whole quantity of the polishing liquid composition. With the addition of less than 0 01% by mass, the wettability of the semiconductor wafer surface after polishing is insufficient. With the addition of 2.0% by mass or more, the viscosity of the polishing composition is too high.

The cellulose derivative includes micron to submicron-size foreign substances, and it is preferable to remove the foreign substances. Microfiltration is suitable for removing the foreign substances. Examples of the filter for use in microfiltration include depth filters, pleated filters, membrane filters, and hollow-fiber filters, any of which can be used. Examples of the materials of the filters include cotton, polypropylene, polystyrene, polysulfone, polyethersulfone, nylon, cellulose, and glass, any of which can be used. The filtration accuracy of filters is expressed by the absolute filtration accuracy (the size of particles captured 99.9% or more). The cellulose derivative is preferably processed with a filter with an absolute filtration accuracy of 0.5 to 1.0 μm in view of production efficiency (the process time, clogging of the filter, and other reasons).

[Polyethylene Glycol]

The polyethylene glycol has a number average molecular weight of 200 to 15,000. In order for LPDs on the semiconductor wafer surface to be further reduced, the number average molecular weight is preferably 10,000 or less and more preferably 5,000 or less.

The amount of the polyethylene glycol added is 0.01% to 0.5% by mass relative to the mass of the whole quantity of the polishing liquid composition. The amount of the polyethylene glycol added of less than 0.01% by mass cannot reduce LPDs. The amount added exceeding 0.5% by mass excessively increases wettability and increases slip, thereby the resistance of the wafer surface to the polishing pad is reduced. The polishing rate then decreases, and LPDs do not decrease accordingly. In order for LPDs on the semiconductor wafer surface to be further reduced, the amount of polyethylene glycol added is preferably 0.02% to 0.4% by mass and more preferably 0.03% to 0.2% by mass.

[Polishing Liquid Composition]

The polishing liquid composition according to the invention in the present application can be prepared in a high-concentration undiluted form and stored or transported. When used with a polisher, the undiluted composition can be diluted with addition of water. The dilution factor is 5 to 100, preferably 10 to 50.

Examples of the semiconductor wafer to which the polishing liquid composition of the invention in the present application is applicable include silicon wafers, SiC wafers, GaN wafers, GaAs wafers, and GaP wafers.

The polisher for polishing semiconductor wafers includes a single-side polishing type and a double-side polishing type. The polishing liquid composition of the invention in the present application can be used in either type.

In a case where coarse particles of 0.5 pm or more are included in the polishing liquid composition of the invention in the present application, the coarse particles have to be removed before polishing. Microfiltration is suitable for removing the coarse particles. Examples of the filter for use in microfiltration include depth filters, pleated filters, membrane filters, and hollow-fiber filters, any of which can be used. Examples of the materials of the filters include cotton, polypropylene, polystyrene, polysulfone, polyethersulfone, nylon, cellulose, and glass, any of which can be used. The filtration accuracy of filters is expressed by the absolute filtration accuracy (the size of particles captured 99.9% or more). The polishing liquid composition of the invention in the present application is preferably processed with a filter with an absolute filtration accuracy of 0.5 μm to 1.0 μm in view of production efficiency (the process time, clogging of the filter, and other reasons).

### EXAMPLES

[Analysis Method and Test Method]

[1] A method of measuring the SF1, [2] a method of measuring the CV value, [3] the primary particle diameter obtained through a nitrogen adsorption method, and [4] measurement of the molecular weight of the water-soluble polymer compound are performed or determined in accordance with the analysis methods [1] to [4] below, respectively, unless otherwise specified. The results are shown in Table 1.

[1] Method of measuring the shape factor SF1 (the degree of sphericalness of particles) through image analysis

An image of sample silica particles was taken at a magnification of 200,000 with a transmission electron microscope (JEM-1010 manufactured by JEOL Ltd.). For any 1000 particles in the obtained projection image, the shape factor SF1 was calculated by Expression (1) below using an image analyzer (NIRECO CORPORATION: LUZEX AP).

SF1=(D_{L}²×π/4)/S (1)

(where D_{L} is the maximum length (nm) of a silica particle obtained from the transmission electron microscope image, and S is the projected area (nm²) of a silica particle).

[2] Method of measuring the coefficient of particle diameter variation CV value (particle diameter distribution)

An image of the sample silica particles was taken at a magnification of 200,000 with a transmission electron microscope (JEM-1010 manufactured by JEOL Ltd.). For any 1000 particles in the obtained projection image, each particle diameter was measured using an image analyzer (NIRECO CORPORATION: LUZEX AP). The mean particle diameter and the standard deviation of the particle diameter were obtained based on the measured values, and the coefficient of particle diameter variation CV value was calculated from Expression (2) below.

CV value (%)=σ/D_{A}×100 (2)

(where σ is the particle diameter standard deviation and D_{A} is the mean particle diameter).

[3] Method of calculating the mean primary particle diameter of silica particles obtained through a nitrogen adsorption method

Ten milliliters of aqueous sol of silica particles was brought into contact with cation exchange resin and dried at 110° C. for 12 hours, and the resultant sample was milled with a mortar. The sample was further dried at 300° C. for one hour to serve as a sample to be measured. Monosorb manufactured by Quantachrome Instruments was used as an analyzer for the nitrogen adsorption (BET) method. The mean primary particle diameter of silica particles was obtained by Expression (3) below using the value of specific surface area calculated by the nitrogen adsorption method.

(3) Mean primary particle diameter (nm)=2727/nitrogen adsorption method specific surface area (m²/g)

[4] Measurement of the molecular weight of the water-soluble polymer compound The weight average molecular weight was measured under the conditions below by gel permeation chromatography.

Column: OHpak SB-806M HQ (8.0 mm ID×300 mm)

Column temperature: 40° C.

Eluent: 0.1 M aqueous sodium nitrate solution

Sample concentration: 0.11% by mass

Flow rate: 0.5 mL/min

Injection amount: 200 μL

Detector: RI (differential refractometer)

[5] Method of evaluating polishing characteristics for semiconductor wafers

Water, ammonia, hydroxyethyl cellulose, and polyethylene glycol were added to silica particles having different SF1 and CV values to prepare polishing liquid compositions, which were filtered through a filter with an absolute filtration accuracy of 1.0 μm. The polishing liquid compositions were diluted by a factor of 40 to obtain polishing slurries. Silicon wafers subjected to primary polishing under the same conditions were subjected to final polishing using the polishing slurries under the conditions below.

Polisher: 900φ single-side machine

Load: 120 g/cm²

Platen rotation speed: 40 rpm

Head rotation speed: 40 rpm

Diluted liquid of polishing composition: 350 ml/min

Polishing duration: 5 minutes

Wafer: silicon wafer P⁻ (100)

The silicon wafer after the final polishing was subjected to known SC1 cleaning (soaked in a cleaning liquid (SC1 liquid) with a mixed ratio of ammonia: hydrogen peroxide: water=1:1 to 2:5 to 7 at 75° C. to 85° C. for 10 to 20 minutes) and SC2 cleaning (soaked in a cleaning liquid (SC2 liquid) including hydrochloric acid: hydrogen peroxide: water=1:1 to 2:5 to 7 at 75° C. to 85° C. for 10 to 20 minutes) to remove impurities on the wafer surface. LPDs on the silicon wafer surface after the final polishing were counted using Surf Scan SP-2 manufactured by KLA-Tencor Corporation. The count of LPDs of 37 nm or more is shown. In Table 1, (0) indicates that the count of LPDs of 37 nm or more per wafer is less than 80, (L.) indicates 80 or more and less than 200, and (X) indicates 200 or more.

### Example 1

156 g of water, 5 g of 28% by mass ammonia water, 59 g of hydroxyethyl cellulose with a weight average molecular weight of 600,000, and 1.5 g of polyethylene glycol with a number average molecular weight of 1,000 were added to 79 g of an aqueous silica sol with a silica concentration of 30% by mass containing silica particles produced from methyl silicate as a raw material with a mean primary particle diameter of 37 nm, an SF1 of 1.11, and a CV value of 7% to prepare a polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 1,000 (with the balance of water, which is applicable in other Examples below). The resultant polishing liquid composition had a pH of 10.7 and an Ostwald viscosity of 3.0 mPa·s at 25° C.

### Example 2

A polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 1,000 was prepared in the same manner as in Example 1 except that an aqueous silica sol with a silica concentration of 30% by mass containing silica particles produced from methyl silicate as a raw material with a mean primary particle diameter of 31 nm, an SF1 of 1.17, and a CV value of 7% was used. The resultant polishing liquid composition had a pH of 10.7 and an Ostwald viscosity of 3.2 mPa·s at 25° C.

### Example 3

A polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 1,000 was prepared in the same manner as in Example 1 except that an aqueous silica sol with a silica concentration of 30% by mass containing silica particles produced from an aqueous sodium silicate solution as a raw material with a mean primary particle diameter of 37 nm, an SF1 of 1.20, and a CV value 12% was used. The resultant polishing liquid composition had a pH of 10.7 and an Ostwald viscosity of 3.1 mPa·s at 25° C.

### Comparative Example 1

A polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 1,000 was prepared in the same manner as in Example 1 except that an aqueous silica sol with a silica concentration of 30% by mass containing silica particles produced from an aqueous sodium silicate solution as a raw material with a mean primary particle diameter of 32 nm, an SF1 of 1.34, and a CV value of 32% was used. The resultant polishing liquid composition had a pH of 10.7 and an Ostwald viscosity of 3.1 mPa·s at 25° C.

### Comparative Example 2

A polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 1,000 was prepared in the same manner as in Example 1 except that an aqueous silica sol with a silica concentration of 30% by mass containing silica particles produced from methyl silicate as a raw material with a mean primary particle diameter of 29 nm, an SF1 of 1.89, and a CV value of 13% was used. The resultant polishing liquid composition had a pH of 10.7 and an Ostwald viscosity of 3.2 mPa·s at 25° C.

### Example 4

156 g of water, 5 g of 28% by mass ammonia water, 59 g of hydroxyethyl cellulose with a weight average molecular weight of 1,200,000, and 1.5 g of polyethylene glycol with a number average molecular weight of 1,000 were added to 79 g of an aqueous silica sol with a silica concentration of 30% by mass containing silica particles produced from methyl silicate as a raw material with a mean primary particle diameter of 31 nm, an SF1 of 1.17, and a CV value of 7% to prepare a polishing liquid composition having a silica concentration of 8% by mass, 0.46% by mass of ammonia, 0.22% by mass of hydroxyethyl cellulose with a weight average molecular weight of 1,200,000, and 0.1% by mass of polyethylene glycol with a number average molecular weight of 1,000. The resultant polishing liquid composition had a pH of 10.7 and an Ostwald viscosity of 7.0 mPa·s at 25° C.

### Example 5

156 g of water, 5 g of 28% by mass ammonia water, 59 g of hydroxyethyl cellulose with a weight average molecular weight of 1,700,000, and 1.5 g of polyethylene glycol with a number average molecular weight of 1,000 were added to 79 g of an aqueous silica sol with a silica concentration of 30% by mass containing silica particles produced from methyl silicate as a raw material with a mean primary particle diameter of 31 nm, an SF1 of 1.17, and a CV value of 7% to prepare a polishing liquid composition having a silica concentration of 8% by mass, 0.46% by mass of ammonia, 0.22% by mass of hydroxyethyl cellulose with a weight average molecular weight of 1,700,000, and 0.1% by mass of polyethylene glycol with a number average molecular weight of 1,000. The resultant polishing liquid composition had a pH of 10.7 and an Ostwald viscosity of 11.0 mPa·s at 25° C.

### Example 6

A polishing liquid composition having a silica concentration of 8% by mass, 0.46% by mass of ammonia, and 0.1% by mass of polyethylene glycol with a number average molecular weight of 1,000 was prepared in the same manner as in Example 5 except that the amount of hydroxyethyl cellulose with a weight average molecular weight of 1,700,000 was 0.43% by mass. The resultant polishing liquid composition had a pH of 10.7 and an Ostwald viscosity of 12.0 mPa·s at 25° C.

### Comparative Example 3

156 g of water, 5 g of 28% by mass ammonia water, and 59 g of hydroxyethyl cellulose with a weight average molecular weight of 600,000 were added to 79 g of an aqueous silica sol with a silica concentration of 30% by mass containing silica particles produced from methyl silicate as a raw material with a mean primary particle diameter of 31 nm, an SF1 of 1.17, and a CV value of 7% to prepare a polishing liquid composition having a silica concentration of 8% by mass, 0.46% by mass of ammonia, and 0.22% by mass of hydroxyethyl cellulose with a weight average molecular weight of 600,000. The resultant polishing liquid composition had a pH of 10.7 and an Ostwald viscosity of 3.2 mPa·s at 25° C.

### Example 7

156 g of water, 5 g of 28% by mass ammonia water, 59 g of hydroxyethyl cellulose with a weight average molecular weight of 600,000, and 1.5 g of polyethylene glycol with a number average molecular weight of 200 were added to 79 g of an aqueous silica sol with a silica concentration of 30% by mass containing silica particles produced from methyl silicate as a raw material with a mean primary particle diameter of 31 nm, SF1 of 1.17, and a CV value of 7% to prepare a polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 200. The resultant polishing liquid composition had a pH of 10.7 and an Ostwald viscosity of 3.1 mPa·s at 25° C.

### Example 8

A polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 10,000 was prepared in the same manner as in Example 7 except that polyethylene glycol with a number average molecular weight of 10,000 was used. The resultant polishing liquid composition had a pH of 10.7 and an Ostwald viscosity of 3.1 mPa·s at 25° C.

### Example 9

A polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 15,000 was prepared in the same manner as in Example 7 except that polyethylene glycol with a number average molecular weight of 15,000 was used. The resultant polishing liquid composition had a pH of 10.7 and an Ostwald viscosity of 3.1 mPa·s at 25° C.

### Comparative Example 4

A polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 100 was prepared in the same manner as in Example 7 except that polyethylene glycol with a number average molecular weight of 100 was used. The resultant polishing liquid composition had a pH of 10.7 and an Ostwald viscosity of 3.2 mPa·s at 25° C.

### Comparative Example 5

A polishing liquid composition having a silica concentration of 8% by mass, 0.46% by mass of ammonia, 0.22% by mass of hydroxyethyl cellulose with a weight average molecular weight of 600,000, and 0.1% by mass of polyethylene glycol with a number average molecular weight of 50,000 was prepared in the same manner as in Example 7 except that polyethylene glycol with a number average molecular weight of 50,000 was used. The resultant polishing liquid composition had a pH of 10.7 and an Ostwald viscosity of 3.1 mPa·s at 25° C.

### Example 10

156 g of water, 5 g of 28% by mass ammonia water, 59 g of hydroxyethyl cellulose with a weight average molecular weight of 1,200,000, and 1.5 g of polyethylene glycol with a number average molecular weight of 600 were added to 79 g of an aqueous silica sol with a silica concentration of 30% by mass containing silica particles produced from methyl silicate as a raw material with a mean primary particle diameter of 31 nm, an SF1 of 1.17, and a CV value of 7% to prepare a polishing liquid composition having a silica concentration of 8% by mass, 0.46% by mass of ammonia, 0.22% by mass of hydroxyethyl cellulose with a weight average molecular weight of 1,200,000, and 0.1% by mass of polyethylene glycol with a number average molecular weight of 600. The resultant polishing liquid composition had a pH of 10.7 and an Ostwald viscosity of 7.0 mPa·s at 25° C.

### Comparative Example 6

A polishing liquid composition having a silica concentration of 8% by mass, 0.46% by mass of ammonia, 0.22% by mass of hydroxyethyl cellulose with a weight average molecular weight of 1,200,000, and 0.1% by mass of polyethylene glycol with a number average molecular weight of 600 was prepared in the same manner as in Example 10 except that an aqueous silica sol with a silica concentration of 30% by mass containing silica particles produced from an aqueous sodium silicate solution as a raw material with a mean primary particle diameter of 32 nm, an SF1 of 1.34, and a CV value of 32%. The resultant polishing liquid composition had a pH of 10.7 and an Ostwald viscosity of 6.8 mPa·s at 25° C.

### Example 11

A polishing liquid composition having a silica concentration of 8% by mass, 0.46% by mass of ammonia, 0.22% by mass of hydroxyethyl cellulose with a weight average molecular weight of 600,000, and 0.05% by mass of polyethylene glycol with a number average molecular weight of 1,000 was prepared in the same manner as in Example 2 except that the amount added of polyethylene glycol with a number average molecular weight of 1,000 was 0.05% by mass. The resultant polishing liquid composition had a pH of 10.7 and an Ostwald viscosity of 3.2 mPa·s at 25° C.

### Example 12

A polishing liquid composition having a silica concentration of 8% by mass, 0.46% by mass of ammonia, 0.22% by mass of hydroxyethyl cellulose with a weight average molecular weight of 600,000, and 0.2% by mass of polyethylene glycol with a number average molecular weight of 1,000 was prepared in the same manner as in Example 2 except that the amount added of polyethylene glycol with a number average molecular weight of 1,000 was 0.2% by mass. The resultant polishing liquid composition had a pH of 10.7 and an Ostwald viscosity of 3.2 mPa·s at 25° C.

### Example 13

A polishing liquid composition having a silica concentration of 8% by mass, 0.46% by mass of ammonia, 0.22% by mass of hydroxyethyl cellulose with a weight average molecular weight of 600,000, and 0.4% by mass of polyethylene glycol with a number average molecular weight of 1,000 was prepared in the same manner as in Example 2 except that the amount added of polyethylene glycol with a number average molecular weight of 1,000 was 0.4% by mass. The resultant polishing liquid composition had a pH of 10.7 and an Ostwald viscosity of 3.2 mPa·s at 25° C.

### Comparative Example 7

A polishing liquid composition having a silica concentration of 8% by mass, 0.46% by mass of ammonia, 0.22% by mass of hydroxyethyl cellulose with a weight average molecular weight of 600,000, and 1.0% by mass of polyethylene glycol with a number average molecular weight of 1,000 was prepared in the same manner as in Example 2 except that 1.0% by mass of polyethylene glycol with a number average molecular weight of 1,000 was added. The resultant polishing liquid composition had a pH of 10.7 and an Ostwald viscosity of 3.2 mPa·s at 25° C.

TABLE 1

| | Mean | | | Hydroxyethyl | | | | |
|---|---|---|---|---|---|---|---|---|
| | primary | | | cellulose | | Polyethylene glycol | | |
| | particle | | CV | | Amount | | Amount | |
| | diameter | | value | Molecular | added | Molecular | added | |
| | (nm) | SF1 | (%) | weight | (%) | weight | (%) | LPD |
| Example 1 | 37 | 1.11 | 7 | 600,000 | 0.22 | 1,000 | 0.1 | ◯ |
| Example 2 | 31 | 1.17 | 7 | 600,000 | 0.22 | 1,000 | 0.1 | ◯ |
| Example 3 | 37 | 1.20 | 12 | 600,000 | 0.22 | 1,000 | 0.1 | ◯ |
| Example 4 | 31 | 1.17 | 7 | 1,200,000 | 0.22 | 1,000 | 0.1 | ◯ |
| Example 5 | 31 | 1.17 | 7 | 1,700,000 | 0.22 | 1,000 | 0.1 | ◯ |
| Example 6 | 31 | 1.17 | 7 | 1,700,000 | 0.43 | 1,000 | 0.1 | ◯ |
| Example 7 | 31 | 1.17 | 7 | 600,000 | 0.22 | 200 | 0.1 | ◯ |
| Example 8 | 31 | 1.17 | 7 | 600,000 | 0.22 | 10,000 | 0.1 | ◯ |
| Example 9 | 31 | 1.17 | 7 | 600,000 | 0.22 | 15,000 | 0.1 | ◯ |
| Example 10 | 31 | 1.17 | 7 | 1,200,000 | 0.22 | 600 | 0.1 | ◯ |
| Example 11 | 31 | 1.17 | 7 | 600,000 | 0.22 | 1,000 | 0.05 | ◯ |
| Example 12 | 31 | 1.17 | 7 | 600,000 | 0.22 | 1,000 | 0.2 | ◯ |
| Example 13 | 31 | 1.17 | 7 | 600,000 | 0.22 | 1,000 | 0.4 | ◯ |
| Comparative | 32 | 1.34 | 32 | 600,000 | 0.22 | 1,000 | 0.1 | Δ |
| Example 1 | | | | | | | | |
| Comparative | 29 | 1.89 | 13 | 600,000 | 0.22 | 1,000 | 0.1 | X |
| Example 2 | | | | | | | | |
| Comparative | 31 | 1.17 | 7 | 600,000 | 0.22 | — | 0.0 | X |
| Example 3 | | | | | | | | |
| Comparative | 31 | 1.17 | 7 | 600,000 | 0.22 | 100 | 0.1 | Δ |
| Example 4 | | | | | | | | |
| Comparative | 31 | 1.17 | 7 | 600,000 | 0.22 | 50,000 | 0.1 | X |
| Example 5 | | | | | | | | |
| Comparative | 32 | 1.34 | 32 | 1,200,000 | 0.22 | 600 | 0.1 | Δ |
| Example 6 | | | | | | | | |
| Comparative | 31 | 1.17 | 7 | 600,000 | 0.22 | 1,000 | 1.0 | Δ |
| Example 7 | | | | | | | | |

As shown in Table 1, in Comparative Examples 1, 2, and 6 in which the SF1 exceeds 1.20, Comparative Example 3 in which polyethylene glycol is not included, Comparative Example 7 in which the amount of polyethylene glycol added exceeds 0.5% by mass, Comparative Example 4 in which the number average molecular weight of polyethylene glycol is less than 200, and Comparative Example 5 in which the number average molecular weight of polyethylene glycol exceeds 15,000, the evaluation results of LPDs are not good. By contrast, in Examples 1 to 13, the evaluation results of LPDs are good.

### INDUSTRIAL APPLICABILITY

The semiconductor wafer polishing liquid composition of the invention in the present application has good final polishing performance and can be suitably used as a polishing liquid composition excellent in reduction of LPDs on a semiconductor wafer surface.

1. A semiconductor wafer polishing liquid composition comprising:
water;
silica particles;
an alkaline compound;
a water-soluble polymer compound; and
polyethylene glycol, wherein
the semiconductor wafer polishing liquid composition satisfies conditions (a) to (c):
(a) a shape factor SF1 of the silica particles as represented by Expression (1) below is 1.00 to 1.20,
SF1=(D_{L}²×π/4)/S (1)
(where D_{L} is the maximum length (nm) of a silica particle obtained from a transmission electron microscope image, and S is a projected area (nm²) of a silica particle),
(b) a mean primary particle diameter of the silica particles that is obtained by a nitrogen adsorption method is 5 nm to 100 nm, and a coefficient of particle diameter variation CV value obtained from image analysis of the transmission electron microscope image is in a range of 0% to 15%, and
(c) the polyethylene glycol has a number average molecular weight of 200 to 15,000.

2. The semiconductor wafer polishing liquid composition according to claim 1, wherein
the alkaline compound is an inorganic salt of an alkali metal and/or an ammonium salt.

3. The semiconductor wafer polishing liquid composition according to claim 2, wherein
the inorganic salt of an alkali metal is at least one selected from the group consisting of lithium hydroxide, sodium hydroxide, potassium hydroxide, lithium carbonate, sodium carbonate, potassium carbonate, lithium hydrogen carbonate, sodium hydrogen carbonate, and potassium hydrogen carbonate.

4. The semiconductor wafer polishing liquid composition according to claim 2, wherein
the ammonium salt is at least one selected from the group consisting of ammonium hydroxide, ammonium carbonate, ammonium hydrogen carbonate, tetramethylammonium hydroxide, tetraethylammonium hydroxide, tetramethylammonium chloride, and tetraethylammonium chloride.

5. The semiconductor wafer polishing liquid composition according to claim 1, wherein
the water-soluble polymer compound is at least one compound selected from the group consisting of a cellulose derivative and a polyvinyl alcohol.

6. The semiconductor wafer polishing liquid composition according to claim 5, wherein
the cellulose derivative is at least one compound selected from the group consisting of carboxymethyl cellulose, hydroxyethyl cellulose, hydroxyethylmethyl cellulose, hydroxypropyl cellulose, hydroxypropylmethyl cellulose, methyl cellulose, ethyl cellulose, ethylhydroxyethyl cellulose, and carboxymethylethyl cellulose.

7. The semiconductor wafer polishing liquid composition according to claim 5, wherein
the cellulose derivative is hydroxyethyl cellulose having a weight average molecular weight of 100,000 to 3,000,000 in terms of polyethylene oxide.

8. The semiconductor wafer polishing liquid composition according to claim 1, wherein
an amount of the silica particles contained is 0.005% to 50% by mass relative to a total mass of the semiconductor wafer polishing liquid composition.

9. The semiconductor wafer polishing liquid composition according to claim 1, wherein
an amount of the alkaline compound contained is 0.001% to 30% by mass relative to the total mass of the semiconductor wafer polishing liquid composition.

10. The semiconductor wafer polishing liquid composition according to claim 1, wherein
an amount of the water-soluble polymer compound contained is 0.01% to 2.0% by mass relative to the total mass of the semiconductor wafer polishing liquid composition.

11. The semiconductor wafer polishing liquid composition according to claim 1, wherein
an amount of the polyethylene glycol contained is 0.01% to 0.5% by mass relative to the total mass of the semiconductor wafer polishing liquid composition.
